(19) United States
(12) Patent Application Publication
(10) Pub. No.: US 2022/0405509 A1
(43) Pub. Date: Dec. 22, 2022

(54) IMAGE PROCESSING METHOD AND DEVICE, EDGE COMPUTING DEVICE, AND COMPUTER STORAGE MEDIUM

(71) Applicant: SENSETIME INTERNATIONAL PTE, LTD., Singapore (SG)

(72) Inventors: Zhiyang GUO, Singapore (SG); Xinxin Wang, Singapore (SG)

(21) Appl. No.: 17/363,438

(22) Filed: Jun. 30, 2021

Related U.S. Application Data
(63) Continuation of application No. PCT/IB2021/055682, filed on Jun. 25, 2021.

(30) Foreign Application Priority Data
Jun. 18, 2021 (SG) 10202106600X

(51) Int. Cl. G06K 9/00; G07F 17/32

(52) U.S. Cl. CPC G06K 9/00744; G06K 9/00771; G07F 17/322; G07F 17/3232; G07F 17/3241

(57) ABSTRACT

The present disclosure provides an image processing method and device, an edge computing device, and a computer storage medium. The method includes: an identification result of each frame of game platform image in a multi-frame game platform image is determined, the identification result including at least information of a capital substitute; and in a case where a N-frame game platform image in the multi-frame game platform image is determined with a sliding window each time, the information of the capital substitute in a target frame of image is redetermined according to the identification result of the N-frame game platform image in the sliding window, where a sliding order of the sliding window is a frame order of the multi-frame game platform image, N is an integer greater than 1, and the target frame of image is one frame of image in the N-frame game platform image in the sliding window.

### CROSS-REFERENCE TO RELATED APPLICATION

This is continuation application of international application PCT/IB2021/055682, filed on 25 Jun. 2021, which claims priority to Singaporean patent application No. 10202106600X, filed with IPOS on 18 Jun. 2021. The contents of international application PCT/IB2021/055682 and Singaporean patent application No. 10202106600X are incorporated herein by reference in their entireties.

### TECHNICAL FIELD

The present disclosure relates to computer vision processing technologies, and relates to, but is not limited to, an image processing method and device, an edge computing device, and a computer storage medium.

### BACKGROUND

At present, a game platform image may be acquired by an image acquisition device, such that the capital substitutes in the game platform image are detected. However, factors such as the occlusion between the capital substitutes, the occlusion of the capital substitutes by the gamer, and the on-site light may affect the accuracy of detection result for the capital substitutes, thereby reducing the identification accuracy of the capital substitute detection to some extent.

### SUMMARY

Embodiments of the present disclosure may provide an image processing method and device, an edge computing device, and a computer storage medium, which are capable of obtaining a detection result for the capital substitute detection more accurately.

The embodiments of the present disclosure provide an image processing method. The method includes the following operations.

An identification result of each frame of game platform image in a multi-frame game platform image is determined, the identification result including at least information of a capital substitute.

In a case where a N-frame game platform image in the multi-frame of game platform image is determined with a sliding window each time, the information of the capital substitute in a target frame of image is redetermined according to the identification result of the N-frame game platform image in the sliding window, where a sliding order of the sliding window is a frame order of the multi-frame game platform image, N is an integer greater than 1, and the target frame of image is one frame of image in the N-frame game platform image in the sliding window.

In some embodiments, redetermining the information of the capital substitute in the target frame of image according to the identification result of the N-frame game platform image in the sliding window includes the following operations.

For the N-frame game platform image in each sliding window, attribute data of a same capital substitute in the identification result of each frame of the N-frame game platform image is determined through target tracking.

Attribute data with most occurrences is determined from the attribute data of the same capital substitute; and the information of the capital substitute in the target frame of image is determined to be the attribute data with the most occurrences.

It to be understood that, due to the factors such as the light-shading effects of the on-site light, the occlusion between the capital substitutes, the occlusion of the capital substitutes by the gamer during game, the movement of the capital substitutes, the information of the capital substitutes in the target frame of image may be inaccurate. In the embodiments of the present disclosure, the attribute data with the most occurrences is determined in the attribute data of the N-frame game platform image, such that the information of the capital substitute in the target frame of image is determined, thereby improving the accuracy of the information of the capital substitutes in the target frame of image to some extent.

In some embodiments, redetermining the information of the capital substitute in the target frame of image according to the identification result of the N-frame game platform image in the sliding window includes the following operations.

For the N-frame game platform image in each sliding window, attribute data of a same capital substitute in the identification result of each frame of the N-frame game platform image is determined through target tracking.

Attribute data with a confidence level greater than or equal to a confidence level threshold is determined from the attribute data to be target attribute data of the capital substitute.

Target attribute data with most occurrences is determined from the target attribute data of a same capital substitute; and the information of the capital substitute in the target frame of image is determined to be the target attribute data with the most occurrences.

It to be understood that in the embodiments of the present disclosure, the attribute data of which the confidence level is greater than or equal to a confidence level threshold is determined in the attribute data of the N-frame game platform image. That is, the target attribute data is determined, such that the information of the capital substitute in the target frame of image is determined according to the target attribute data with the most occurrences, thereby improving the accuracy of the information of the capital substitute in the target frame of image to some extent.

In some embodiments, redetermining the information of the capital substitute in the target frame of image according to the identification result of the N-frame game platform image in the sliding window includes the following operations.

For the N-frame game platform image in each sliding window, attribute data of at least two capital substitutes in the identification result of the N-frame game platform image is determined.

Attribute data of each of the at least two capital substitutes is determined from the attribute data of the at least two capital substitutes through a tracking identifier of each of the at least two capital substitutes.

Attribute data with most occurrences is determined respectively for each of the at least two capital substitutes.

The information of the capital substitute in the target frame of image is determined to be the attribute data with the most occurrences determined for each of the capital substitutes.

It to be understood that in the embodiments of the present disclosure, the attribute data of the different capital substitutes in the N-frame game platform image may be determined according to the tracking identifiers of the capital substitutes, such that for the attribute data of the at least two capital substitutes, the attribute data with the most occurrences may be determined, and further the information of the capital substitute in the target frame of image is determined, thereby improving the accuracy of the information of the capital substitute in the target frame of image.

In some embodiments, the attribute data of the capital substitute includes at least one of: a denomination of the capital substitute, a type of the capital substitute, a quantity of the capital substitute, or information of an owner of the capital substitute.

It can be seen that, according to the embodiments of the present disclosure, the information such as denomination, quantity, type of the capital substitutes may be determined accurately.

In some embodiments, the N-frame game platform image is consecutive N frames of image in the multi-frame game platform image.

According to the embodiments of the present disclosure, the information of the capital substitute in the target frame of image may be obtained more accurately based on the information of the capital substitute of the consecutive N frames of image.

In some embodiments, the target frame of image is a frame of image in the N-frame game platform image with earliest acquisition time.

As such, according to the embodiments of the present disclosure, the information of the capital substitute of the frame of image with the earliest acquisition time in the N-frame game platform image with the earliest acquisition time may be obtained, thereby obtaining accurate information of the capital substitute in time.

In some embodiments, the method further includes the following operation.

Service detection logic associated with the capital substitute is executed according to the information of the capital substitute in the target frame of image.

According to the embodiments of the present disclosure, the service detection logic associated with the capital substitute may be executed accurately on the basis of accurately obtaining the information of the capital substitute in the target frame of image, thereby reducing the probability of a false alarm due to incorrect information of the capital substitute to some extent.

In some embodiments, executing service detection logic associated with the capital substitute according to the information of the capital substitute in the target frame of image includes the following operations.

A human hand detection box and a capital substitute detection box in the target frame of image are determined.

In a case where the hand detection box does not overlap with the capital substitute detection box, the service detection logic associated with the capital substitute is executed according to the information of the capital substitute in the target frame of image.

It can be seen that, according to the embodiments of the present disclosure, the service detection logic associated with the capital substitute may be executed for the capital substitute which does not overlap the human hand, such that the service detection logic associated with the capital substitute may be executed when it is determined that the human hand does not occlude the capital substitute, thereby reducing the probability of a service detection logic error due to occlusion of the capital substitute by the human hand to some extent.

In some embodiments, executing the service detection logic associated with the capital substitute according to the information of the capital substitute in the target frame of image includes the following operations.

Change information of the information of the capital substitute in multiple target frames of image is determined according to the redetermined information of the capital substitute in the multiple target frames of image arranged in a chronological order.

The change information is pushed to a management device of a game platform.

It can be seen that, according to the embodiments of the present disclosure, the change information of the capital substitute may be pushed in time, thereby facilitating subsequent processing on the change information of the capital substitute at the management device end.

In some embodiments, determining the identification result of each frame of the multi-frame game platform image includes the following operations.

A target object in each frame of image is identified, the identified target object is mapped to a predetermined area partitioning map, and an identification result of each predetermined area for said each frame of image is obtained.

In the embodiments of the present disclosure, the predetermined area partitioning map may accurately represent the target object of each area in the game platform. Therefore, the identified target object is mapped to the predetermined area partitioning map, and the identification result of each frame of image may be obtained more accurately.

The embodiments of the present disclosure further provide an image processing device. The device includes a determination module and a processing module.

The determination module is configured to determine an identification result of each frame of game platform image in the multi-frame game platform image. The identification result includes at least information of a capital substitute.

The processing module is configured to, in a case where a N-frame game platform image in the multi-frame of game platform image is determined with a sliding window each time, redetermine the information of the capital substitute in a target frame of image according to the identification result of the N-frame game platform image in the sliding window, where a sliding order of the sliding window is a frame order of the multi-frame game platform image, N is an integer greater than 1, and the target frame of image is one frame of image in the N-frame game platform image in the sliding window.

In some embodiments, the processing module is configured to redetermine the information of the capital substitute in a target frame of image according to the identification result of N-frame game platform image in the sliding window, which includes the following operations.

For the N-frame game platform image in each sliding window, attribute data of a same capital substitute in the identification result of each frame of the N-frame game platform image is determined through target tracking.

The attribute data with the most occurrences is determined from the attribute data of the same capital substitute.

The information of the capital substitute in the target frame of image is determined to be the attribute data with the most occurrences.

In some embodiments, the processing module is configured to redetermine the information of the capital substitute in the target frame of image according to the identification result of the N-frame game platform image in the sliding window, which includes the following operations.

For the N-frame game platform image in each sliding window, attribute data of a same capital substitute in the identification result of each frame of the N-frame game platform image is determined through target tracking.

Attribute data with a confidence level greater than or equal to a confidence level threshold is determined from the attribute data to be target attribute data of the capital substitute.

Target attribute data with most occurrences is determined from the target attribute data of a same capital substitute.

The information of the capital substitute in the target frame of image is determined to be the target attribute data with the most occurrences.

In some embodiments, the processing module is configured to redetermine the information of the capital substitute in the target frame of image according to the identification result of the N-frame game platform image in the sliding window, which includes the following operations.

For the N-frame game platform image in each sliding window, attribute data of at least two capital substitutes in the identification result of the N-frame game platform image is determined.

Attribute data of each of the at least two capital substitutes is determined from the attribute data of the at least two capital substitutes through a tracking identifier of each of the at least two capital substitutes.

Attribute data with most occurrences is determined respectively for each of the at least two capital substitutes.

The information of the capital substitute in the target frame of image is determiend to be the attribute data with the most occurrences determined for each of the capital substitutes.

In some embodiments, the attribute data of the capital substitute includes at least one of: a denomination of the capital substitute, a type of the capital substitute, a quantity of the capital substitute, or information of an owner of the capital substitute.

In some embodiments, the N-frame game platform image is consecutive N frames of image in the multi-frame game platform image.

In some embodiments, the target frame of image is a frame of image in the N-frame game platform image with the earliest acquisition time.

In some embodiments, the processing module is further configured to execute service detection logic associated with the capital substitute according to the information of the capital substitute in the target frame of image.

In some embodiments, the processing module is configured to execute service detection logic associated with the capital substitute according to the information of the capital substitute in the target frame of image, which includes the following operations.

A human hand detection box and a capital substitute detection box in the target frame of image are determined.

In a case where the hand detection box does not overlap with the capital substitute detection box, the service detection logic associated with the capital substitute is executed according to the information of the capital substitute in the target frame of image.

In some embodiments, the processing module is configured to execute service detection logic associated with the capital substitute according to the information of the capital substitute in the target frame of image, which includes the following operations.

Change information of the information of the capital substitute in the multiple target frames of image is determined according to the redetermined information of the capital substitute in the multiple target frames of image arranged in a chronological order.

The change information is pushed to a management device of a game platform.

In some embodiments, the determination module is configured to determine the identification result of each frame of game platform image in the multi-frame game platform image, which includes the following operation.

A target object in each frame of image is identified, the identified target object is mapped to a predetermined area partitioning map, and an identification result of each predetermined area for said each frame of image is obtained.

The embodiments of the present disclosure further provide an edge computing device. The edge computing device is configured to receive a multi-frame game platform image sent by a image acquisition device. The multi-frame game platform image is an image acquired by the image acquisition device.

The edge computing device includes a processor and a memory configured to store computer programs executable on the processor.

The processor is configured to execute the computer programs to perform any image processing method described above.

The embodiments of the present disclosure further provide a computer storage medium having stored thereon computer programs which, when executed by a processor, implements any image processing method described above.

According to the image processing method and device, the edge computing device, and the computer storage medium in the embodiments of the present disclosure, an identification result of each frame of game platform image in a multi-frame game platform image is determined, the identification result including at least information of a capital substitute; in a case where a N-frame game platform image in the multi-frame game platform image is determined with a sliding window each time, the information of the capital substitute in a target frame of image is redetermined according to the identification result of the N-frame game platform image in the sliding window, where a sliding order of the sliding window is a frame order of the multi-frame game platform image, N is an integer greater than 1, and the target frame of image is one frame of image in the N-frame game platform image in the sliding window.

It can be seen that, in the embodiments of the present disclosure, the identification result of the N-frame game platform image in the sliding window may be used to determine the information of the capital substitute in the target frame of image. Since the identification result of the N-frame game platform image contains much more information and more accurate information of the capital substitute, the information of the capital substitute in the target frame of image may be obtained more accurately according to the embodiments of the present disclosure, thereby improving the identification accuracy of the capital substitute effectively.

It is to be understood that both the foregoing general description and the following detailed description are exemplary and explanatory only and are not to limit the disclosure.

### BRIEF DESCRIPTION OF THE DRAWINGS

The accompanying drawings, which are incorporated in and constitute a part of the specification, illustrate embodiments consistent with the present disclosure and, together with the description, serve to illustrate the technical solution of the disclosure.

FIG. 1 is a flowchart of an image processing method according to an embodiment of the present disclosure;

FIG. 2A is a reference diagram of a game platform image in accordance with an embodiment of the present disclosure;

FIG. 2B is a diagram of the partitioning of areas for capital substitutes obtained based on FIG. 2A;

FIG. 3 is a structural diagram of an image processing device according to an embodiment of the present disclosure;

FIG. 4 is a structural diagram of an edge computing device according to an embodiment of the present disclosure.

### DETAILED DESCRIPTION

The present disclosure is described in further detail below with reference to the accompanying drawings and embodiments. It is to be understood that the embodiments provided herein are merely illustrative of the disclosure and are not intended to limit the disclosure. In addition, the following embodiments are part rather than all of the embodiments for carrying out the present disclosure. The technical solutions described in the embodiments of the present disclosure may be carried out in any combination without conflict.

It should be noted that in the embodiments of the present disclosure, the terms “comprise”, “contain” or any other variation thereof, are intended to encompass a non-exclusive inclusion, such that a method or device comprising a list of elements comprises not only the elements expressly recited, but also other elements not expressly listed, or elements inherent to the method or device. Without more limitations, an element defined by the statement “comprising a . . . ” does not rule out additional relevant elements in the method or device comprising the element (e.g., a step in the method, or an element in the device such as a part of a circuit, a part of a processor, a part of a program or software, etc.).

For example, the image processing method provided in the embodiments of the present disclosure include a series of steps. However, the image processing method provided in the embodiments of the present disclosure is not limited to the steps described. Similarly, the image processing device provided in the embodiments of the present disclosure includes a series of modules. However, the device provided in the embodiments of the present disclosure is not limited to the modules specifically described, and may further include the modules required for obtaining the related information or performing the processes according to the information.

The term “and/or” as used herein merely describes an association relationship of associated objects, meaning that there may be three kinds of relationship. For example, A and/or B may mean three kinds of relationship: A alone, both A and B, and B alone. Additionally, the term “at least one” as used herein denotes any combination of: at least one of multiple objects or any combination of at least two of multiple objects. For example, including at least one of A, B, C, may denote the inclusion of any one or more elements selected from the group consisting of A, B and C.

The embodiments of the present disclosure may be applied to edge computing devices in game scenarios and may operate with numerous other general-purpose or special-purpose computing system environments or configurations. Here, the edge computing device may be a thin client, a thick client, a handheld or laptop device, a microprocessor-based system, a set-top box, a programmable consumer electronics product, a network personal computer, a minicomputer system, or the like.

The edge computing device may execute instructions through a program module. Generally, program modules may include routines, programs, target programs, components, logic, data structures, etc., which perform particular tasks or implement particular abstract data types. The computer system/server may be implemented in a distributed cloud computing environment in which tasks are performed by remote processing devices linked through a communication network. In a distributed cloud computing environment, program modules may be located on a local or remote computing system storage medium including a storage device.

In the related art, in a game scenario, the information of the capital substitute is required for the calculation of a game result, alarm detection of a capital substitute (e g, minimum denomination of a capital substitute, maximum denomination of a capital substitute), and the like. The service detection logic associated with the capital substitute can be accurately executed only through accurate information of the capital substitute, so as to meet the requirements for the game scenario. However, in the actual game scenario, there are a large number of objective factors which affect the identification result of the capital substitute, causing errors in the information of the capital substitute. For example, the factors such as the light-shading effects of the on-site light, the occlusion between the capital substitutes (the capital substitutes are close to each other and different capital substitutes are at different heights), the occlusion of the capital substitutes by the gamer during the game, the movement of the capital substitutes, or the like, may cause a jump of the result of the capital substitute detection. Therefore, how to improve the accuracy of the detection result of the capital substitute is an urgent technical problem to be solved.

In view of the above technical problems, in some embodiments of the present disclosure, a technical solution for image processing is provided, which may be applied to a game scenario.

An application scenario of an embodiment of the present disclosure is exemplarily described below.

In game scenarios, the operating state of various games may be monitored with computer vision processing technologies. Herein, the operating state of each game is associated with a capital substitute.

In some embodiments, a game in a game scenario may be a poker card game or other games on a game platform, which are not limited in the embodiments of the present disclosure.

In the embodiments of the present disclosure, the computer vision is a science that studies how to allow a machine to “see”, and refers to identifying, tracking, and measuring an object with a camera and a computer instead of the human eye, and further performing image processing. Three cameras may be used during the game to detect events happening on the game platform for further analysis. The game platform may be an entity desktop platform or other entity platforms.

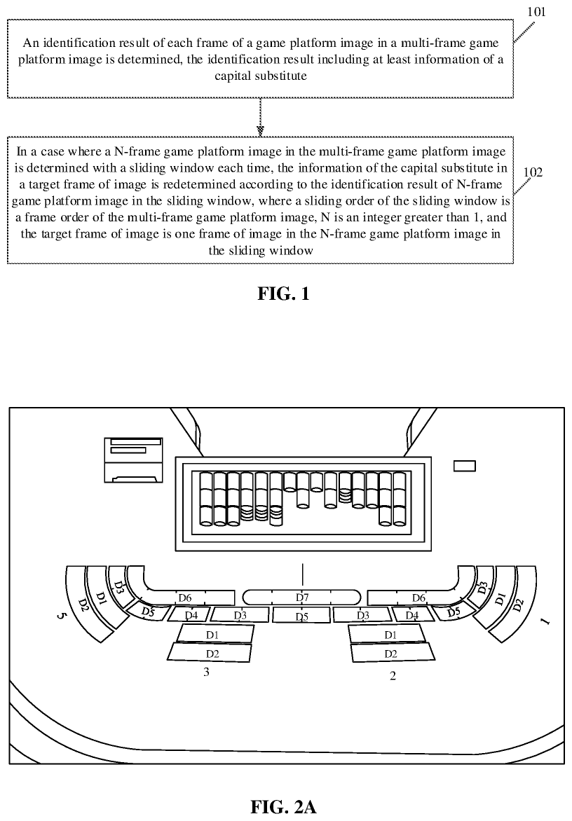

FIG. 1 is a flowchart of an image processing method according to an embodiment of the present disclosure. As illustrated in FIG. 1, the flow may include steps 101 to 102.

In 101, an identification result of each frame of game platform image in a multi-frame game platform image is determined, the identification result including at least information of a capital substitute.

In the embodiment of the present disclosure, at least one camera may be used to photograph a game platform to obtain video data or image data. Then a multi-frame game platform image from the video data or image data may be obtained. In some embodiments, the camera photographing the game platform may be a camera located directly above the game platform for photographing the game platform at a top view, or may be a camera photographing the game platform from other angles. Accordingly, each frame of game platform image may be a game platform image at the top view or from other angles. In other embodiments, each frame of game platform image may further be an image obtained through a fusion process on the game platform image at the top view and the game platform image from other angles.

After each frame of image is obtained, each frame of game platform image may be processed by a computer vision processing technology to obtain an identification result of each frame of game platform image. In some embodiments, target identification may be performed on each frame of game platform image to obtain a target object in each frame of game platform image. The target object includes at least a capital substitute. Exemplarily, the target object may further include a human body or a poker card, and the human body in the target object may include an entire human body, or part of a human body such as a human hand, a human face. The poker card in the target object may be a card of a type of spade, heart, diamond or club. After the target object in each frame of image is obtained, a corresponding identification result may be determined according to the target object in each frame of image. Here, the identification result may be information of the target object.

In some embodiments, the information of the capital substitute may include attribute data of the capital substitute, and the attribute data of the capital substitute may include at least one of a denomination of the capital substitute, a type of the capital substitute, a quantity of the capital substitute, information of an owner of the capital substitute. In practical applications, the information of the capital substitute may be determined for one capital substitute. In this case, the quantity of the capital substitute is 1. Multiple capital substitutes in contact with each other may be taken as a same capital substitute, so as to analyze the information of the same capital substitute. In this case, the quantity of the capital substitute is greater than 1. For example, for a stack of capital substitutes, the stack of capital substitutes may be taken as a same capital substitute, and the quantity of capital substitutes of the stack of capital substitutes is greater than 1. The information of the owner of the capital substitute may include identity information of the owner of the capital substitute.

In some embodiments, information such as the denomination of the capital substitute, the type of the capital substitute, the quantity of the capital substitute may be determined through analyzing the image of the capital substitute. The information of the owner of the capital substitute may be determined according to the image of the human body in contact with the capital substitute.

In 102, in a case where a N-frame game platform image in the multi-frame game platform image is determined with a sliding window each time, the information of the capital substitute in a target frame of image is redetermined according to the identification result of the N-frame game platform image in the sliding window, where a sliding order of the sliding window is a frame order of the multi-frame game platform image, N is an integer greater than 1, and the target frame of image is one frame of image in the N-frame game platform image in the sliding window.

In some embodiments, the size of the sliding window may be preset through the configuration file, i.e., the value of N may be configured through the configuration file. After the identification result of each frame of game platform image is obtained, the identification result of each frame of game platform image may be sequentially stored in the storage area corresponding to the sliding window in a chronological order. In some embodiments, the identification result of each frame of game platform image is located in a message queue; with the identification result of each frame in the message queue being read, the read identification result of each frame of image may be stored in turn into the storage area corresponding to the sliding window. When the quantity of the identification results in the sliding window reaches N, if the identification result of a new frame of image in the message queue is to be read, the sliding window moves, such that a frame of image is pushed out, and the identification result of the frame of image pushed out may be obtained. The identification result of the target frame of image indicates an identification result of a frame of image that changes from in the sliding window to outside the sliding window after the sliding window moves.

In some embodiments, the edge computing device may be utilized to receive the multi-frame game platform image sent by the image acquisition device. The multi-frame game platform image is a image acquired by the image acquisition device. The image acquisition device may include at least one camera as described above.

Accordingly, each frame of game platform image in the multi-frame game platform image may be detected and identified by the edge computing device to obtain an identification result of each frame of game platform image in the multi-frame game platform image. The information of the capital substitute in the target frame of image is determined by the edge computing device according to the identification result of the N-frame game platform image in the sliding window.

In practical applications, steps 101 to 102 may be implemented with a processor in the edge computing device. The processor may be at least one of: an Application Specific Integrated Circuit (ASIC), a Digital Signal Processor (DSP), a Digital Signal Processing Device (DSPD), a Programmable Logic Device (PLD), a Field—Programmable Gate Array (FPGA), a Central Processing Unit (CPU), a controller, a microcontroller, or a microprocessor.

It can be seen that, in the embodiments of the present disclosure, the identification result of the multi-frame game platform image in the sliding window may be used to determine the information of the capital substitute in the target frame of image. Since the identification result of the multi-frame game platform image contains much more information and more accurate information of the capital substitute, the information of the capital substitute in the target frame of image may be obtained more accurately according to the embodiments of the present disclosure, thereby improving the identification accuracy of the capital substitute effectively.

Further, the embodiments of the present disclosure may be applied not only to a game scenario of poker cards, but also to a variety of scenarios in which capital substitutes are used, such that the usage cost may be reduced, and accurate identification of the information of the capital substitute may be achieved at a faster speed, which is easy to implement.

In some embodiments, that the identification result of each frame of game platform image in the multi-frame game platform image is determined may include that a target object in each frame of image is identified, the identified target object is mapped to a predetermined area partitioning map, and an identification result of each predetermined area for the each frame of image is obtained.

The target object may include the capital substitute, and may also include other objects such as game props in the game platform image. Exemplarily, the target object in each frame of image may be one or more. The area partitioning diagram may be used to represent the correct area in which the various types of target objects are located. After any one of the target objects is mapped to the predetermined area partitioning diagram, and if the target object is located in the corresponding correct area in the area partitioning diagram, the information of the target object is retained in the identification result of each frame of game platform image; and if the target object is not in the corresponding correct area in the area partitioning diagram, the information of the target object may be filtered and deleted from the identification result of each frame of game platform image.

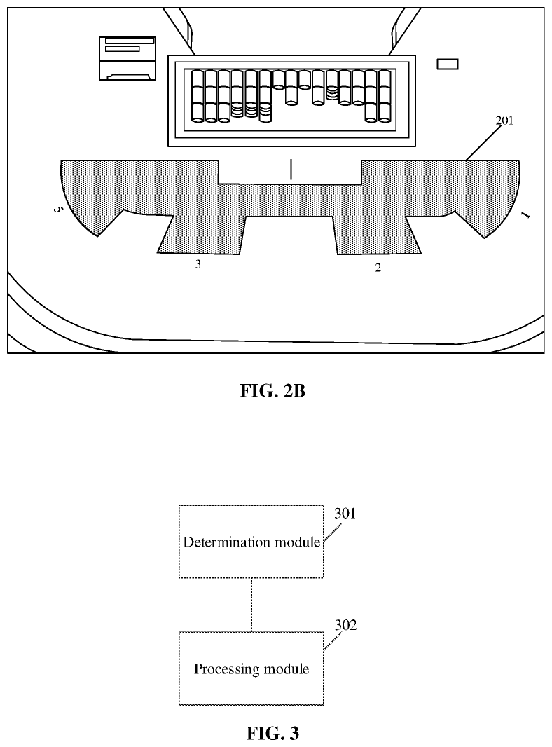

Exemplarily, FIG. 2A is a reference diagram of a game platform image in an embodiment of the present disclosure. In FIG. 2A, D1, D2, D3, D4, D5, D6 and D7 represent different areas in the game platform.

FIG. 2B is a diagram of the partitioning of area for a capital substitute obtained based on FIG. 2A. It can be seen that, the area 201 for the capital substitute is illustrated in FIG. 2B and includes the areas D1 to D7 in FIG. 2A.

Referring to FIG. 2B, in a case where the target object is a capital substitute, if the capital substitute is located in the area 201 for the capital substitute in FIG. 2B, the information of the capital substitute is retained; and if the capital substitute is located outside the area 201 for the capital substitute illustrated in FIG. 2B, the information of the capital substitute is deleted.

It can be seen that, the predetermined area partitioning map may accurately represent the target object of each area in the game platform. Therefore, the identified target object is mapped to the predetermined area partitioning map, and the identification result of each predetermined area for each frame of image may be obtained more accurately.

In some embodiments, the N-frame game platform image may be a disconsecutive N frames of image in the multi-frame game platform image or consecutive N frames of image in the multi-frame game platform image. In a case where the above-described N-frame game platform image is a consecutive N frames of image, according to the embodiments of the present disclosure, the information of the capital substitute in the target frame of image may be obtained more accurately based on the information of the capital substitute in the consecutive N frames of image.

In some embodiments, the target frame of image is a frame of image with the earliest acquisition time in the N-frame game platform image. In this manner, the information of the frame of image in the N-frame game platform image with the earliest acquisition time may be obtained according to the embodiments of the present disclosure, thereby obtaining accurate information of the capital substitute in time.

In one implementation, the value of N is 5, the identification results of the first frame of image to the fifth frame of image may be sequentially stored in the sliding window. When the number of the identification results in the sliding window reaches 5, if the identification result of the sixth frame of image is to be stored in the sliding window, the right edge of the sliding window moves to the right, and the identification result of the first frame of image is pushed out of the sliding window. At the moment, the first frame of image is the target frame of image. When the identification result of the first frame of image is pushed out of the sliding window, the data in the sliding window is the identification results of the second frame of image to the sixth frame of image. Then, if the identification result of the seventh frame of image is to be stored in the sliding window, the right edge of the sliding window moves to the right, such that the identification result of the second frame of image is pushed out of the sliding window. At the moment, the second frame of image is the target frame of image. When the identification result of the second frame of image is pushed out of the sliding window, the data in the sliding window is the identification results of the third frame of image to the seventh frame of image. By analogy, multiple target frames of image and respective identification results thereof may be determined in sequence with the sliding mechanism of the sliding window.

In some embodiments, that the information of the capital substitute in the target frame of image is redetermined according to the identification result of the N-frame game platform image in the sliding window may include the following operations.

For the N-frame game platform image in each sliding window, attribute data of a same capital substitute in the identification result of each frame of the N-frame game platform image is determined through target tracking; attribute data with most occurrences is determined from the attribute data of the same capital substitute; and the information of the capital substitute in the target frame of image is determined to be the attribute data with the most occurrences.

In the embodiment of the present disclosure, the same capital substitute includes at least one capital substitute. For the identification result of the N-frame game platform image, the attribute data of the same capital substitute may be determined in the identification result of the N-frame game platform image through target tracking. In some embodiments, a tracking identifier of the capital substitute in the target frame of image is determined by a target detection method; and then, according to the track identity document (id) of the capital substitute in the target frame of image, the target tracking is performed in the identification result of the N-frame game platform image in the sliding window, thereby determining attribute data of the same capital substitute in the identification result of the N-frame game platform image. Exemplarily, the tracking identifier may be the track id.

In the embodiment of the present disclosure, after the attribute data of the same capital substitute is determined, the attribute data with the most occurrences may be determined by election from the attribute data of the same capital substitute.

In some embodiments, when the attribute data includes the denomination of the capital substitute, the denomination data with the most occurrences may be determined by election from the attribute data of the same capital substitute. For example, the value of N is 5, the data in the sliding window is the identification results of the first frame of image to the fifth frame of image, and the target frame of image is the first frame of image. According to the identification results of the first frame of image to the fifth frame of image, the denomination of the same capital substitute in the first frame of image to the fifth frame of image may be identified. When the denominations of the capital substitutes with the same tracking ID in the first frame of image, the second frame of image, the third frame of image, the fourth frame of image, and the fifth frame of image are identified as 200, 200, 300, 300, and 300, respectively, the denomination with the most occurrences may be determined to be 300 by election. Thus, the denomination of the corresponding capital substitute in the first frame of image may be considered to be inaccurate, and the denomination of the corresponding capital substitute in the first frame of image may be updated to 300. When the denominations of the capital substitutes with the same tracking ID in the first frame of image, the second frame of image, the third frame of image, the fourth frame of image, and the fifth frame of image are identified as 400, 400, 400, 400 and 300, respectively, the denomination of the capital substitute in the first frame of image may be determined to be 400 by election. In this case, it may be considered that the denomination of the capital substitute in the first frame of image is accurate, and the denomination of the capital substitute in the first frame of image may be kept unchanged at 400.

As such, after the denomination of the capital substitute in the first frame of image is determined, the sliding window may be moved backwards, the first frame of image is pushed out of the sliding window, and the second frame of image becomes the first frame in the sliding window. At the moment, the information of the capital substitute in the second frame of image is updated according to the identification results of the second frame of image to the seventh frame of image in the sliding window. As a result, the sliding window is sequentially moved backwards in turn according to the order of frames, such that the information of the capital substitutes in the first frame, the second frame, the third frame, or the like may be updated so as to obtain a reliable identification result of the video frame sequence.

In some embodiments, when the attribute data includes the quantity of the capital substitutes, information on the quantity of the capital substitutes with the most occurrences may be determined by election from the attribute data of the same capital substitute. For example, the value of N is 5, the data in the sliding window is the identification result of the first frame of image to the fifth frame of image, and the target frame of image is the first frame of image, the quantity of the same capital substitutes in the first frame of image to the fifth frame of image may be identified according to the identification results of the first frame of image to the fifth frame of image. In a case where the quantity of the capital substitutes with the same tracking ID in the first frame of image, the second frame of image, the third frame of image, the fourth frame of image, and the fifth frame of image are identified as 3, 3, 4, 4 and 4, respectively, the quantity of the capital substitutes with the most occurrences may be determined to be 4 by election. As such, it may be considered that the quantity of the capital substitutes in the first frame of image is inaccurate, and the quantity of the capital substitutes in the first frame of image may be updated to 4. In a case where the quantity of the capital substitutes with the same tracking ID in the first frame of image, the second frame of image, the third frame of image, the fourth frame of image, and the fifth frame of image are identified as 4, 4, 4, 4 and 3, respectively, the quantity of the capital substitutes with the most occurrences may be determined to be 4 by election. In this way, it may be considered that the quantity of the capital substitutes in the first frame of image is accurate, and the quantity of the capital substitutes in the first frame of image may be kept unchanged at 4.

It to be understood that the information of the capital substitute in the target frame of image may be inaccurate due to light-shading effects of the on-site light, the occlusion between the capital substitutes, the occlusion of the capital substitutes by the gamer during the game, the movement of the capital substitutes, or the like. In the embodiment of the present disclosure, the information of the capital substitute with the most occurrences may be determined from the information of the capital substitute in the N-frame game platform image, and the accuracy of the information of the capital substitute in the target frame of image may be improved to some extent.

In some embodiments, that the information of the capital substitute in the target frame of image is redetermined according to the identification result of the N-frame game platform image in the sliding window may include the following operations.

For the N-frame game platform image in each sliding window, attribute data of a same capital substitute in the identification result of each frame of the N-frame game platform image is determined through target tracking; attribute data with a confidence level greater than or equal to a confidence level threshold is determined from the attribute data to be target attribute data of the capital substitute; target attribute data with most occurrences is determined from the target attribute data of a same capital substitute; and the information of the capital substitute in the target frame of image is determined to be the target attribute data with the most occurrences.

Here, the confidence level threshold may be preset according to actual application requirements. Exemplarily, the confidence level threshold may be 0.9 or 1. The implementation for determining the attribute data with the most occurrences by election has been described in the foregoing contents, and will not be repeated here.

It is to be understood that in the embodiments of the present disclosure, the attribute data of which the confidence level is greater than or equal to the confidence level threshold is determined in the attribute data of the N-frame game platform image. That is, the target attribute data is determined. In this way, the information of the capital substitute in the target frame of image is determined according to the target attribute data with the most occurrences, and the accuracy of the information of the capital substitute in the target frame of image may be improved to some extent.

In some embodiments, that the information of the capital substitute in the target frame of image is determined according to the identification result of the N-frame game platform image in the sliding window may include the following operations: for the N-frame game platform image in each sliding window, attribute data of at least two capital substitutes in the identification result of the N-frame game platform image is determined; attribute data of each of the at least two capital substitutes is determined from the attribute data of the at least two capital substitutes through a tracking identifier of each of the at least two capital substitutes; attribute data with most occurrences is determined respectively for each of the at least two capital substitutes; and the information of the capital substitute in the target frame of image is determined to be the attribute data with the most occurrences determined for each of the capital substitutes.

In some embodiments, the attribute data includes denominations of the capital substitutes, and the tracking ids of different capital substitutes are id-1 and id-2, respectively. The target tracking is performed in the identification result of the N-frame game platform image in the sliding window based on id-1, thereby determining the attribute data of the capital substitute of which the tracking id is id-1 in the identification result of the N-frame game platform image. Then, in the attribute data of the capital substitute of which the tracking id is id-1 corresponding to the N-frame game platform image, the attribute data with the most occurrences is determined by election as described above, and the information of the capital substitute of which the tracking id is id-1 in the target frame of image is determined to be the determined attribute data with the most occurrences. Similarly, the information of the capital substitute of which the tracking id is id-2 in the target frame of image may be determined for the capital substitute of which the tracking id is id-2.

It is to be understood that in the embodiment of the present disclosure, the attribute data of each of the at least two capital substitutes in the N-frame game platform image may be determined according to the tracking identifier of the capital substitute, such that the attribute data with the most occurrences may be determined for each of the at least two capital substitutes, thereby determining the information of the capital substitute in the target frame of image, and improving the accuracy of the information of the capital substitute in the target frame of image to some extent.

In some embodiments, after the information of the capital substitute in the target frame of image is determined, the service detection logic associated with the capital substitute may be executed according to the information of the capital substitute in the target frame of image.

In the embodiment of the present disclosure, the service detection logic associated with the capital substitute may be: determining whether a game on the current game platform allows to bet with a particular type of capital substitute, determining whether the denomination of the capital substitute is less than the lower limit of the denomination specified in the game, determining whether the denomination of the capital substitute is greater than the upper limit of the denomination specified in the game, acquiring information of the capital substitute used in the game by the owner of the capital substitute, or the like. It should be noted that the above description is merely an exemplary description of the service detection logic associated with the capital substitute, and the embodiments of the present disclosure is not limited thereto.

In some embodiments, that the service detection logic associated with the capital substitute is executed according to the information of the capital substitute in the target frame of image may include the following operations: a human hand detection box and a capital substitute detection box in the target frame of image are determined; and the service detection logic associated with the capital substitute is executed according to the information of the capital substitute in the target frame of image in a case where the human hand detection box does not overlap with the capital substitute detection box.

In an embodiment of the present disclosure, the human hand detection box and the capital substitute detection box of the target frame of image may be determined by performing human hand detection and capital substitute detection on the target frame of image. In some embodiments, the target frame of image may be input to a first neural network for the human hand detection and a second neural network for the capital substitute detection, respectively; and the target frame of image is processed using the first neural network and the second neural network to obtain the human hand detection box and the capital substitute detection box of the target frame of image. The embodiments of the present disclosure does not limit the network structure of the first neural network and the second neural network. For example, each of the first neural network and the second neural network may be a Single Shot MultiBox Detector (SSD), You Only Look Once (YOLO), Faster Region-Convolutional Neural Networks (Faster RCNN), or other neural networks based on deep learning.

According to the embodiment of the present disclosure, the degree of overlap between the human hand detection box and the capital substitute detection box in the target frame of image may be calculated according to the human hand detection box and the capital substitute detection box in the target frame of image. When the degree of overlap is greater than 0, it may be considered that the human hand detection box and the capital substitute detection box in the target frame of image overlap each other. When the degree of overlap is equal to 0, it may be considered that the human hand detection box and the capital substitute detection box in the target frame of image do not overlap.

In some embodiments, in a case where the human hand detection box and the capital substitute detection box overlap each other, the information of the capital substitute corresponding to the capital substitute detection box may be acquired in the identification result of the target frame of image. That is, the relevant service detection logic is not performed according to the information of the capital substitute corresponding to the capital substitute detection box.

In one implementation of executing the service detection logic associated with the capital substitute, in a case where the human hand detection box and the capital substitute detection box do not overlap, the corresponding capital substitute in the target frame of image may be determined as a stable capital substitute. In this case, the type of the capital substitute that is currently allowed to be betted on the game platform may be determined according to the pre-configured configuration file, so as to determine whether the game platform allows the capital substitute identified as stable to be used in the game according to the type of the capital substitute identified as stable.

It can be seen that, in the embodiment of the present disclosure, the service detection logic associated with the capital substitute may be performed for the capital substitute which do not overlap the human hand, such that the service detection logic associated with the capital substitute may be performed in a case where it is determined that the human hand does not occlude the capital substitute, and the probability of a service detection logic error due to occlusion of the capital substitute by the human hand may be reduced to some extent.

In some embodiments, the change information of the information of the capital substitute in the multiple target frames of image may be determined according to the redetermined information of the capital substitute in the multiple target frames of image arranged in the chronological order, and the change information is pushed to the management device of the game platform.

In practical applications, the information such as the quantity or denomination of the capital substitutes may be changed for the capital substitutes with the same tracking id in the multiple target frames of image. In order to facilitate the manager to know the change information of the capital substitutes timely, in the embodiments of the present disclosure, the corresponding change information may be pushed after it is determined that the information of the capital substitute changes in the multiple target frames of image, thereby facilitating subsequent processing of the change information of the capital substitute at the management device end.

An embodiment of the present disclosure is described by way of example with reference to an application scenario. In the application scenario, the game scenario is a smart casino scenario, the game platform is a gambling table, and the capital substitute is a chip.

The smart casino scenario may be a poker card game, and an operating state of the poker card game may include a idle state, a betting state, a gaming state, a payout state, and a halt state.

Exemplarily, the poker card game may be a Baccarat or other types of games. In a Baccarat game scenario, the dealer draws 4 to 6 cards from 3 to 8 decks of poker cards that have been shuffled, and a win-loss result may be output according to a rule. The win-loss result may include a player, a dealer, a tie, a super six, or the like. The gamer and the casino calculate their respective money gains and losses according to the win-loss result of each game, the odds in different scenes, and whether or not to draw a commission. The dealer deals cards and the gamer squints cards according to certain rules, and an alarm message needs to be given when the rules are violated.

In the smart casino scenario, the multi-frame gambling table image may be acquired by the camera and then the acquired multi-frame gambling table image is sent to the edge computing device of the smart casino. In the edge computing device, each frame of gambling table image in the multi-frame gambling table image is detected and identified to obtain an identification result of each frame of gambling table image of the multi-frame gambling tables image.

In a case where a N-frame gambling table image is determined each time using the sliding window, the edge computing device may determine the chip information in the target frame of image according to the identification result of the N-frame gambling table image in the multi-frame gambling table image in the sliding window. The target frame of image is a frame of image in the N-frame gambling table image in the sliding window.

In one implementation, the edge computing device may further execute the service detection logic associated with the chip according to the chip information in the target frame of image.

Exemplarily, the service detection logic associated with the chip may include: determining whether the game on the current gambling table allows a particular type of chip to be betted, determining whether the denomination of the chip is less than a lower limit of denomination specified in the game, determining whether the denomination of the chip is greater than an upper limit of denomination specified in the game, acquiring information of the chip used in the game by the owner of the chip, or the like. It should be noted that the above description is merely an exemplary description of service detection logic associated with the chip, and the embodiments of the present disclosure is not limited thereto.

In some scenarios, it is required by the casino to perform the service detection logic inside the casino according to the real-time change information of chips on the table in the casino. Therefore, accurate chip information is acquired. For this requirement, the service detection logic associated with the chip may be executed accurately on the basis of accurately obtaining the chip information in the target frame of image according to the embodiments of the present disclosure, such that the probability of phenomenons such as a false alarm due to incorrect chip information may be reduced to some extent.

It will be appreciated by those skilled in the art that in the abovementioned methods of detailed implementation, the order in which the steps are described does not imply a strict order of execution to constitute any limitation to the implementation, and that the specific order of execution of the steps should be determined in terms of their functions and possible intrinsic logic.

On the basis of the image processing method provided in the foregoing embodiments, the embodiments of the present disclosure provide an image processing device.

FIG. 3 is a structural diagram of an image processing device according to an embodiment of the present disclosure. As illustrated in FIG. 3, the device may include a determination module 301 and a processing module 302.

The determination module 301 is configured to determine an identification result of each frame of a game platform image in a multi-frame game platform image, the identification result including at least the information of the capital substitute.

The processing module 302 is configured to, in a case where a N-frame game platform image in the multi-frame game platform image is determined with a sliding window each time, redetermine the information of the capital substitute in a target frame of image according to the identification result of the N-frame game platform image in the sliding window, where a sliding order of the sliding window is a frame order of the multi-frame game platform image, N is an integer greater than 1, and the target frame of image is one frame of image in the N-frame game platform image in the sliding window.

In some embodiments, the processing module 302 is configured to redetermine the information of the capital substitute in the target frame of image according to the identification result of the N-frame game platform image in the sliding window, which includes the following operations.

For the N-frame game platform image in each sliding window, attribute data of a same capital substitute in the identification result of each frame of the N-frame game platform image is determined through target tracking.

Attribute data with most occurrences is determined from the attribute data of the same capital substitute.

The information of the capital substitute in the target frame of image is determined to be the attribute data with the most occurrences.

In some embodiments, the processing module 302 is configured to redetermine the information of the capital substitute in the target frame of image according to the identification result of the N-frame game platform image in the sliding window, which includes the following operations.

For the N-frame game platform image in each sliding window, attribute data of a same capital substitute in the identification result of each frame of the N-frame game platform image is determined through target tracking.

Attribute data with a confidence level greater than or equal to a confidence level threshold from the attribute data is determined to be target attribute data of the capital substitute.

Target attribute data with most occurrences is determined from the target attribute data of a same capital substitute.

The information of the capital substitute in the target frame of image is determined to be the target attribute data with the most occurrences.

In some embodiments, the processing module 302 is configured to redetermine the information of the capital substitute in the target frame of image according to the identification result of the N-frame game platform image in the sliding window, which includes the following operations.

For the N-frame game platform image in each sliding window, attribute data of at least two capital substitutes in the identification result of the N-frame game platform image is determined.

Attribute data of each of the at least two capital substitutes is determined from the attribute data of the at least two capital substitutes through a tracking identifier of each of the at least two capital substitutes.

Attribute data with most occurrences is determined respectively for each of the at least two capital substitutes.

The information of the capital substitute in the target frame of image is determined to be the attribute data with the most occurrences determined for each of the capital substitutes.

In some embodiments, the attribute data of the capital substitute includes at least one of: a denomination of the capital substitute, a type of the capital substitute, a quantity of the capital substitute, or information of an owner of the capital substitute.

In some embodiments, the N-frame game platform image is consecutive N frames of image in the multi-frame game platform image.

In some embodiments, the target frame of image is a frame of image in the N-frame game platform image with the earliest acquisition time.

In some embodiments, the processing module 302 is further configured to execute service detection logic associated with the capital substitute according to the information of the capital substitute in the target frame of image.

In some embodiments, the processing module 302 is configured to execute the service detection logic associated with the capital substitute according to the information of the capital substitute in the target frame of image, which includes the following operations.

A human hand detection box and a capital substitute detection box in the target frame of image are determined.

The service detection logic associated with the capital substitute is executed according to the information of the capital substitute in the target frame of image in a case where the human hand detection box does not overlap with the capital substitute detection box.

In some embodiments, the processing module 302 is configured to execute the service detection logic associated with the capital substitute according to the information of the capital substitute in the target frame of image, which includes the following operations.

Change information of the information of the capital substitute in multiple target frames of image is redetermined according to the redetermined information of the capital substitute in the multiple target frames of image arranged in a chronological order.

The change information is pushed to a management device of the game platform.

In some embodiments, the determination module 301 is configured to determine the identification result of each frame of the multi-frame game platform image, which includes the following operation.

A target object in each frame of image is identified, the identified target object is mapped to a predetermined area partitioning map, and an identification result of each predetermined area for said each frame of image is obtained.

In practical applications, each of the determination module 301 and the processing module 302 may be implemented by a processor in an edge computing device. The processor may be at least one of an ASIC, a DSP, a DSPD, a PLD, an FPGA, a CPU, a controller, a microcontroller, or a microprocessor.

In addition, the functional modules in the present embodiment may be integrated in one processing unit, or each unit may physically exist alone, or two or more units may be integrated in one unit. The integrated units described above may be implemented in the form of hardware or in the form of software functional modules.

The integrated unit, when not sold or used as a stand-alone product in the form of a software functional module, may be stored in a computer-readable storage medium. It is understood that the technical solution of the present embodiment may be embodied in the form of a software product in which instructions are included to cause a computer device (which may be a personal computer, a server, a network device, or the like) or a processor to perform all or a part of the steps of the methods described in the present embodiments. The storage medium includes a USB flash drive, a removable hard disk, a Read Only Memory (ROM), a Random Access Memory (RAM), a magnetic disk, or an optical disk.

Specifically, a computer program instruction corresponding to an image processing method in the present embodiment may be stored on a storage medium such as an optical disk, a hard disk, or a USB flash disk. When the computer program instruction in the storage medium corresponding to the image processing method is read or executed by an electronic device, any one of the methods for image processing in the foregoing embodiments is implemented.

According to the same technical concept of the foregoing embodiments, the embodiments of the present disclosure further provide an edge computing device. The edge computing device is configured to receive a multi-frame game platform image sent by an image acquisition device. The multi-frame game platform image is a image acquired by the image acquisition device.

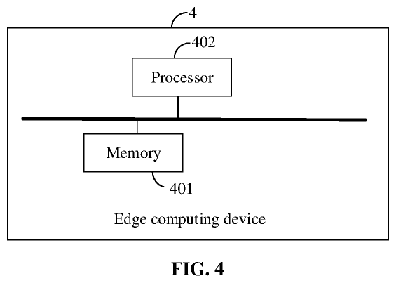

Referring to FIG. 4, an edge computing device 4 according to an embodiment of the present disclosure may include a memory 401 and a processor 402.

The memory 401 is configured to store computer programs and data.

The processor 402 is configured to execute the computer programs stored in the memory to implement any image processing method in the foregoing embodiments.

In practical applications, the memory 401 may be a volatile memory such as a RAM; or a non-volatile memory such as ROM, a flash memory, a Hard Disk Drive (HDD) or a Solid-State Drive (SSD); or a combination of memories of the kinds described above. The memory 401 provides instructions and data to the processor 402.

The processor 402 may be at least one of an ASIC, a DSP, a DSPD, a PLD, an FPGA, a CPU, a controller, a microcontroller, or a microprocessor. It is to be understood that for different devices, the electronic elements for implementing the above-described processor functions may be other elements, and the embodiments of the present disclosure are not specifically limited.

In some embodiments, the device provided in the embodiments of the present disclosure may have functions or include modules for performing the methods described in the abovementioned method embodiments. For the specific implementations thereof, references may be made to the abovementioned method embodiments, and details are not described herein for brevity.

The foregoing description of the embodiments is intended to emphasize the differences between the embodiments. For the same or similar parts of the embodiments, references may be made to each other, and details are not described herein for the sake of brevity.

The methods disclosed in the method embodiments provided herein may be combined arbitrarily without conflict to obtain new method embodiments.

The features disclosed in the product embodiments provided herein may be combined arbitrarily without conflict to obtain new product embodiments.

The features disclosed in each method or device embodiment provided in the present application may be combined arbitrarily without conflict to obtain a new method embodiment or device embodiment.

From the above description of the embodiments, it is apparent to those skilled in the art that the methods of the abovementioned embodiments may be implemented by means of software plus the necessary general hardware platform, or may be implemented by means of hardware, and in many cases the former is the preferred embodiment. According to such an understanding, the essence or the part which contributes to the prior art of the technical solution of the present disclosure may be embodied in the form of a software product stored in a storage medium (such as a ROM/RAM, a magnetic disk, or an optical disk) including instructions to cause a terminal (which may be a mobile phone, a computer, a server, an air conditioner, or a network device) to perform the methods described in the embodiments of the present disclosure.

The embodiments of the present disclosure have been described above in connection with the accompanying drawings, but the present disclosure is not limited to the foregoing detailed description, which is merely illustrative and not restrictive. Many modifications may be made by those of ordinary skill in the art without departing from the spirit of the disclosure and the scope of the claims, all of which are within the protection of the disclosure.

1. An image processing method, comprising:
determining an identification result of each frame of game platform image in a multi-frame game platform image, wherein the identification result comprises at least information of a capital substitute; and
in a case where a N-frame game platform image in the multi-frame game platform image is determined with a sliding window each time, redetermining the information of the capital substitute in a target frame of image according to the identification result of the N-frame game platform image in the sliding window, wherein a sliding order of the sliding window is a frame order of the multi-frame game platform image, N is an integer greater than 1, and the target frame of image is one frame of image in the N-frame game platform image in the sliding window.

2. The method of claim 1, wherein redetermining the information of the capital substitute in the target frame of image according to the identification result of the N-frame game platform image in the sliding window comprises:
determining, for the N-frame game platform image in each sliding window, attribute data of a same capital substitute in the identification result of each frame of the N-frame game platform image through target tracking;
determining attribute data with most occurrences from the attribute data of the same capital substitute; and
determining the information of the capital substitute in the target frame of image to be the attribute data with the most occurrences.

3. The method of claim 1, wherein redetermining the information of the capital substitute in the target frame of image according to the identification result of the N-frame game platform image in the sliding window comprises:
determining, for the N-frame game platform image in each sliding window, attribute data of a same capital substitute in the identification result of each frame of the N-frame game platform image through target tracking;
determining attribute data with a confidence level greater than or equal to a confidence level threshold from the attribute data to be target attribute data of the capital substitute;
determining target attribute data with most occurrences from the target attribute data of a same capital substitute; and
determining the information of the capital substitute in the target frame of image to be the target attribute data with the most occurrences.

4. The method of claim 1, wherein redetermining the information of the capital substitute in the target frame of image according to the identification result of the N-frame game platform image in the sliding window comprises:
determining, for the N-frame game platform image in each sliding window, attribute data of at least two capital substitutes in the identification result of the N-frame game platform image;
determining, from the attribute data of the at least two capital substitutes, attribute data of each of the at least two capital substitutes through a tracking identifier of each of the at least two capital substitutes;
determining attribute data with most occurrences respectively for each of the at least two capital substitutes; and
determining the information of the capital substitute in the target frame of image to be the attribute data with the most occurrences determined for each of the capital substitutes.

5. The method of claim 2, wherein the attribute data of the capital substitute comprises at least one of: a denomination of the capital substitute, a type of the capital substitute, a quantity of the capital substitute, or information of an owner of the capital substitute.

6. The method of claim 3, wherein the attribute data of the capital substitute comprises at least one of: a denomination of the capital substitute, a type of the capital substitute, a quantity of the capital substitute, or information of an owner of the capital substitute.

7. The method of claim 4, wherein the attribute data of the capital substitute comprises at least one of: a denomination of the capital substitute, a type of the capital substitute, a quantity of the capital substitute, or information of an owner of the capital substitute.

8. The method of claim 1, wherein the N-frame game platform image is consecutive N frames of image in the multi-frame game platform image.

9. The method of claim 1, wherein the target frame of image is a frame of image in the N-frame game platform image with earliest acquisition time.

10. The method of claim 1, wherein the method further comprises:
executing service detection logic associated with the capital substitute according to the information of the capital substitute in the target frame of image.

11. The method of claim 10, wherein executing the service detection logic associated with the capital substitute according to the information of the capital substitute in the target frame of image comprises:
determining a human hand detection box and a capital substitute detection box in the target frame of image; and
in a case where, the human hand detection box does not overlap with the capital substitute detection box, executing the service detection logic associated with the capital substitute according to the information of the capital substitute in the target frame of image.

12. The method of claim 10, wherein executing the service detection logic associated with the capital substitute according to the information of the capital substitute in the target frame of image comprises:
determining change information of the information of the capital substitute in a plurality of target frames of image according to the redetermined information of the capital substitute in the plurality of target frames of image arranged in a chronological order; and
pushing the change information to a management device of a game platform.

13. The method of claim 1, wherein determining the identification result of each frame of the multi-frame game platform image comprises:
identifying a target object in each frame of image, mapping the identified target object to a predetermined area partitioning map, and obtaining an identification result of each predetermined area for the each frame of image.

14. An edge computing device, wherein the edge computing device is configured to receive a multi-frame game platform image sent by an image acquisition device; the multi-frame game platform image is an image acquired by the image acquisition device;
the edge computing device comprises a processor and a memory configured to store computer programs executable on the processor;
wherein the processor is configured to execute the computer programs to:
determine an identification result of each frame of game platform image in a multi-frame game platform image, wherein the identification result comprises at least information of a capital substitute; and
in a case where a N-frame game platform image in the multi-frame game platform image is determined with a sliding window each time, redetermine the information of the capital substitute in a target frame of image according to the identification result of the N-frame game platform image in the sliding window, wherein a sliding order of the sliding window is a frame order of the multi-frame game platform image, N is an integer greater than 1, and the target frame of image is one frame of image in the N-frame game platform image in the sliding window.

15. The edge computing device of claim 14, wherein the processor is configured to:
determine, for the N-frame game platform image in each sliding window, attribute data of a same capital substitute in the identification result of each frame of the N-frame game platform image through target tracking;
determine attribute data with most occurrences from the attribute data of the same capital substitute; and
determine the information of the capital substitute in the target frame of image to be the attribute data with the most occurrences.

16. The edge computing device of claim 14, wherein the processor is configured to:
determine, for the N-frame game platform image in each sliding window, attribute data of a same capital substitute in the identification result of each frame of the N-frame game platform image through target tracking;
determine attribute data with a confidence level greater than or equal to a confidence level threshold from the attribute data to be target attribute data of the capital substitute;
determine target attribute data with most occurrences from the target attribute data of a same capital substitute; and
determine the information of the capital substitute in the target frame of image to be the target attribute data with the most occurrences.

17. The edge computing device of claim 14, wherein the processor is configured to:
determine, for the N-frame game platform image in each sliding window, attribute data of at least two capital substitutes in the identification result of the N-frame game platform image;
determine, from the attribute data of the at least two capital substitutes, attribute data of each of the at least two capital substitutes through a tracking identifier of each of the at least two capital substitutes;
determine attribute data with most occurrences respectively for each of the at least two capital substitutes; and
determine the information of the capital substitute in the target frame of image to be the attribute data with the most occurrences determined for each of the capital substitutes.

18. A nonvolatile computer-readable storage medium having stored thereon computer programs which, when executed by a processor, implement an image processing method, the method comprising:
determining an identification result of each frame of game platform image in a multi-frame game platform image, wherein the identification result comprises at least information of a capital substitute; and
in a case where a N-frame game platform image in the multi-frame game platform image is determined with a sliding window each time, redetermining the information of the capital substitute in a target frame of image according to the identification result of the N-frame game platform image in the sliding window, wherein a sliding order of the sliding window is a frame order of the multi-frame game platform image, N is an integer greater than 1, and the target frame of image is one frame of image in the N-frame game platform image in the sliding window.
